(19) United States
(12) Patent Application Publication
(10) Pub. No.: US 2026/0217260 A1
(43) Pub. Date: Jul. 30, 2026

(54) METHOD FOR CARRYING OUT SETTINGS ON AT LEAST ONE FIRST ACTUATOR OF A MOTOR VEHICLE, METHOD FOR ENABLING SETTINGS TO BE CHANGED, AND MOTOR VEHICLE

(71) Applicant: AUDI AG, Ingolstadt (DE)

(72) Inventors: Benjamin POPPINGA, Wettstetten (DE); Simon SEITLE, Oberhausen (DE)

(73) Assignee: AUDI AG, Ingolstadt (DE)

(21) Appl. No.: 19/141,887

(22) PCT Filed: Nov. 14, 2023
(86) PCT No.: PCT/EP2023/081698

§ 371 Date: Jun. 20, 2025

(30) Foreign Application Priority Data
Dec. 22, 2022 (DE) 10 2022 134 639.0

(51) Int. Cl. B60W 50/00; H04L 9/00

(52) U.S. Cl. CPC B60W 50/00; H04L 9/50

(57) ABSTRACT

Carrying out settings on at least one first actuator of a motor vehicle may include predefining a first setting for the at least one first actuator, obtaining, based on a first NFT, first data which predefine a second setting, and using the obtained data to change the first setting into the second setting.

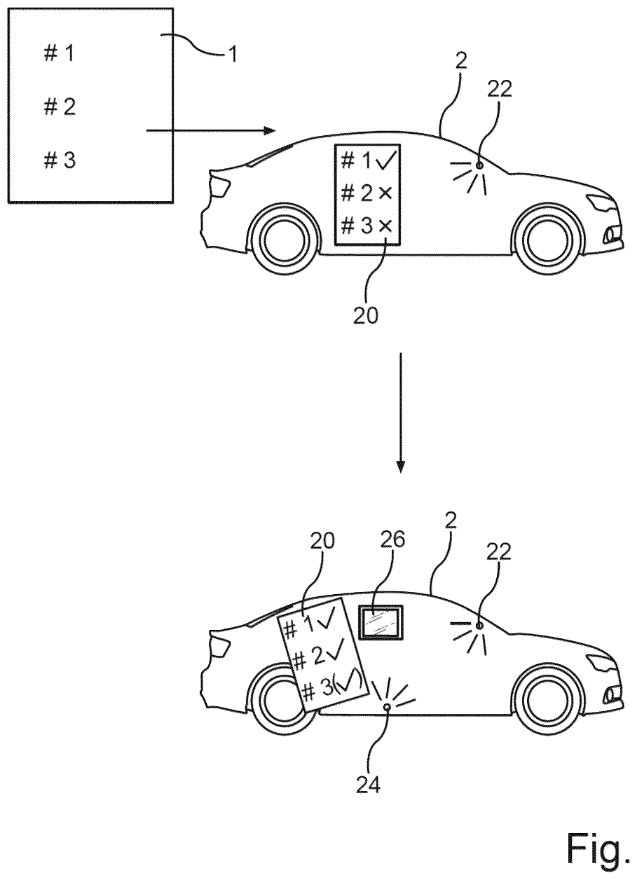

### CROSS-REFERENCE TO RELATED APPLICATIONS

This application is a U.S. national stage of International Application No. PCT/EP2023/081698, filed on Nov. 14, 2023, which claims the priority benefit of German Patent Application No. 10 2022 134 639.0 filed on Dec. 22, 2022. Both the International Application and the German Patent Application are incorporated by reference herein in their entirety.

### BACKGROUND

### 1. Field

An invention according to described examples relates to a method for carrying out settings on at least one first actuator of a motor vehicle, a method for enabling settings to be changed, and a motor vehicle.

### 2. Description of the Related Art

The ever-increasing multiplicity of actuators in motor vehicles-here, primarily involving actuators which relate to the passenger compartment of the vehicle-offer veritable worlds of experience to the vehicle occupant. A plurality of colored lights (in the form of light-emitting diodes, LEDs), audio experiences, olfactory experiences through fragrancing and haptic experiences can be combined with one another.

The user increasingly desires particularly exclusive vehicle experiences.

Control commands which can form part of an exclusive purchase can thus be defined for the actuators. It must be then ensured here that the vehicle experience cannot be enjoyed through unauthorized manipulations by persons who have acquired no right thereto.

US 2021/0133713 A1 discloses a system based on distributed ledger networks—for example blockchain or DAG—for managing property rights. In this context, a non-fungible token is generated which represents the right to use the property asset. The creation of a non-fungible token is referred to as “minting”.

From the field of autonomous vehicles, it is known from DE 11 2020 003 484 T5 to store operating commands for the autonomous vehicle on a blockchain, for example so that a gas pedal setting is reproducible.

According to U.S. Pat. No. 11,238,478 B2, a blockchain can also be used to update ledgers in motor vehicles. The purpose of the method described in this document is to offer the user products commercially.

### SUMMARY

Example objects of the invention according to described examples are to find a way to provide users with authentic vehicle experiences.

The example objects may be achieved by a method for carrying out settings on at least one first actuator of a motor vehicle, by a method of enabling settings to be changed on at least one actuator of a motor vehicle, and by a motor vehicle having the features of the methods, according to the claims.

The method according to the examples of the invention for carrying out settings on at least one first actuator of a motor vehicle comprises predefining a first setting for the at least one first actuator, obtaining, based on a first NFT, first data which predefine a second setting, and finally using the obtained data to change the first setting into the second setting.

The invention according to the examples thus makes use of the concept of non-fungible tokens, NFTs, in order to ensure increased legal certainty when trading in data of this type which predefine settings for actuators (i.e. more or less when trading in control commands).

According to an example, the NFT itself comprises a file containing control commands for the at least one first actuator. Such a file is therefore linked to further data when the NFT is minted.

Alternatively, it is possible for the NFT to comprise a data path to a file containing control commands for the at least one first actuator. The data path can relate, for example, to the World Wide Web, wherein the URL number uniquely indicates where the file can be found. Alternatively, the control commands can be stored in the motor vehicle itself and can be activated using the NFT only in the motor vehicle. In the latter case, it can be assumed that a central server is provided (in particular a platform for which the automobile manufacturer is responsible), where the purchaser/lessee/other user of the motor vehicle can perform acquisition transactions (purchases, leases, etc., an NFT and the associated control commands).

A typical format for files containing control commands is the . xml format, where “xml” stands for “Extensible Markup Language”. This format is generally suitable for storing more or less any type of data. These data can be interpreted as a control command if they are ordered in a predetermined way. The type of ordering of the data can be indicated in an .xsl (“Extensible Stylesheet Language”) file.

In an example of the invention, the second setting directly replaces the first setting. The vehicle experience can thus comprise the essential predominance of white light in the motor vehicle (according to the first setting), and the acquisition by the user, based on the NFT, of the right to activate red lights as the second setting (the actuator then comprises the group of lights, including both the white and the red lights).

Equally, a sound-emitting device (loudspeaker, equalizer) can essentially also have a first setting, which is replaced by a second setting as the method is carried out.

Alternatively, it is possible that the first setting simply temporally follows the first setting, i.e. the vehicle experience continues over a longer time period if the user has acquired the corresponding right with the NFT, wherein the time period for example lasts between 1 second and 1 minute.

According to an example, second data which predefine the third settings are obtained based on a second NFT. This can be purely complementary, but may be such that the second data, together with the first data, predefine a fourth setting. If the user were therefore to obtain only the second NFT alone, the third setting would be carried out instead of the first setting. However, since the user has now already acquired the first NFT, the user is thus provided with the more advantageous fourth setting. The examples apply to the third and/or fourth settings as above to the second setting (they replace the first setting or another of the settings or temporally follow the first/other setting).

In the case of lighting, it can be provided, for example, that the second setting uses red light, the third setting uses blue light, and the fourth setting relates to a violet hue which is created—albeit directly—through the combination of red and blue light. Alternatively, green light, as a combination of the purchase of red and blue light, can be provided as a fourth setting. This can also be performed serially: the first setting with the white light can be replaced by the second setting with the red light and then by the third setting with the blue light, whereupon, with the purchase of the blue light in addition to the red light, the green light is finally emitted as the fourth setting.

Alternatively or additionally, it is possible that a first setting is also predefined for at least one second actuator, third data which predefine a second setting for the at least one second actuator are obtained based on a third NFT, and the third data are used to change the first setting of the second actuator into a second setting.

It then may be further provided for this purpose that a setting for a third actuator is additionally changed. It is thus conceivable, for example, in an action experience world, that the first NFT relates to lighting actuators responsible for the passenger compartment of the vehicle as first actuators, that the second NFT relates to the actuators responsible for sounds in the passenger compartment of the vehicle as second actuators, and that, as the third actuator, it is then provided that a signature tune is played to the user and/or that a light sequence is provided when the user opens the vehicle door and enters the passenger compartment of the vehicle.

The method for enabling settings to be changed on at least one actuator of a motor vehicle according to the examples of the invention comprises minting at least one NFT that links a file, in particular an . xml file, containing control commands for the at least one actuator to further data (for example to an identifier indicating the vehicle type in which the control commands are appropriately usable, or an identifier for a specific (hardware) equipment feature in the motor vehicle and the like). After minting, the at least one NFT is recorded on a block chain. The file containing the control commands can be accessed through access to the NFT following the acquisition of the corresponding right.

The motor vehicle according to the examples of the invention comprises at least one actuator and an associated control unit which is configured to retrieve, from an internal memory of the motor vehicle, or externally download at least one file, in particular an . xml file, containing control commands for the at least one actuator via at least one data path determined by an NFT, and to implement the control commands, wherein the control commands are implemented as required, in particular immediately and/or once further conditions apply.

In cases or situations which can occur in the method and which are not explicitly described here, it can be provided that an error message and/or a prompt to enter user feedback is output and/or a default setting and/or a predetermined initial state is set according to the method.

The invention according to the examples also relates to the control unit for the motor vehicle. The control unit can have a data processing device or a processor device which is configured to implement the method according to the examples of the invention. The processor device can have at least one microprocessor and/or at least one microcontroller and/or at least one FPGA (Field Programmable Gate Array) and/or at least one DSP (Digital Signal Processor) for this purpose. The processor device can further have program code which is configured, when executed by the processor device, to implement the method according to the examples of the invention. The program code can be stored in a data memory of the processor device. The processor circuit of the processor device can have e.g. at least one printed circuit board and/or at least one SoC (System on Chip).

The invention according to the examples also relates to developments of the motor vehicle which have features that have already been described in connection with the developments of the method according to the examples of the invention. For this reason, the corresponding developments of the motor vehicle according to the examples of the invention are not described here again.

The motor vehicle according to the examples of the invention may be configured as an automobile, in particular a passenger vehicle or a truck, or as a passenger bus or motorcycle.

As a further solution, the examples of the invention also comprise a computer-readable storage medium, comprising commands which, when executed by a computer or a computer network, cause the latter to implement the method according to examples of the invention. The storage medium can be configured e.g. at least partially as a non-volatile data memory (e.g. as a flash memory and/or as an SSD-solid state drive) and/or at least partially as a volatile data memory (e.g. as a RAM-random access memory). However, the storage medium can also be operated, for example, as an app store server on the Internet. A processor circuit having at least one microprocessor can be provided by a computer or a computer network. The commands can be provided as binary code or assembler and/or as source code of a programming language (e.g. C).

The examples of the invention also comprises the combinations of the features of the described examples. The examples of the invention therefore also comprises implementations which in each case have a combination of the features of a plurality of the described examples, unless the examples have been described as mutually exclusive.

### BRIEF DESCRIPTION OF DRAWINGS

Examples of the invention are described below.

The single FIGURE shows schematically how settings can be changed on actuators in a motor vehicle, according to an example.

### DESCRIPTION

The method assumes that NFTs have already been minted, e.g. by the vehicle manufacturer or special design studios, wherein these NFTs convey the rights to provide specific experiences for the user of the vehicle, mainly in the passenger compartment of the vehicle, wherein the examples of the invention may also implementable on other actuators which do not relate directly to the passenger compartment of the vehicle.

Referring to the FIGURE, a list 1 of the hash values for the NFTs is provided. This list 1 is transmitted to the motor vehicle 2 and is received there by a component 20, which is conceivable as a central control unit. The component 20 in the motor vehicle 2 then checks the wallet linked to a user account of the owner/lessee/user in order to establish which NFTs are in the possession of the user. In the example shown in the FIGURE, the tick after #1 indicates that the NFT 1 belongs to the user, but not the NFTs 2 and 3. The NFTs in the possession of the user are offered for activation in the vehicle, where corresponding groups of control commands are stored and are activatable so that the experience components can consequently be activated separately or jointly.

The NFT 1 is therefore first active here, so that, in the example, an actuator 22 is activated for the lighting. The user can additionally acquire the NFT 2, as shown on the bottom right of the figure. A rule can specify that the NFT 3 is thereby also activated. Correspondingly, along with the actuator 22 based on the NFT 1, an actuator 24 is activated for sound based on the NFT 2 and the display 26 is activated based on the NFT 3 in the motor vehicle 2.

The ownership status of an experience component is checked regularly before the activation of the experience such that an experience that is no longer stored as an NFT in the wallet of the user is not activated. The user interface (control unit 20) of the vehicle indicates this to the user in this case.

The examples explained below are examples of the invention. The described examples are also supplementable by further of the features of the examples of the invention already described.

It has been shown that a method for NFT-based configuration of an exclusive vehicle experience can be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1.-12. (canceled)

13. A method for carrying out settings on at least one first actuator of a motor vehicle, comprising:
predefining a first setting for the at least one first actuator,
obtaining, based on a first NFT, first data which predefine a second setting,
using the obtained data to change the first setting into the second setting.

14. The method as claimed in claim 13, wherein the first NFT itself contains a file containing control commands for the at least one first actuator.

15. The method as claimed in claim 13, wherein the first NFT contains a data path to a file containing control commands for the at least one first actuator.

16. The method as claimed in claim 14, wherein the control commands are stored in the motor vehicle itself and are activated using the first NFT.

17. The method as claimed in claim 14, wherein the file is or comprises an .xml file.

18. The method as claimed in claim 13, wherein the second setting replaces the first setting.

19. The method as claimed in claim 13, wherein the second setting temporally follows the first setting.

20. The method as claimed in claim 13, further comprising:
obtaining, based on a second NFT, second data which alone predefine a third setting, and the second data in combination with the first data predefine a fourth setting.

21. The method as claimed in claim 13, wherein the first setting is also predefined for at least one second actuator, third data which predefine the second setting for the at least one second actuator are obtained based on a third NFT, and the third data are used to change the first setting of the at least one second actuator into the second setting.

22. The method as claimed in claim 21, wherein a setting of a third actuator is additionally changed.

23. A method for enabling settings to be changed on at least one actuator of a motor vehicle, comprising:
minting at least one NFT that links a file, in particular an . xml file, containing control commands for at least one actuator to further data;
recording the at least one NFT on a block chain.

24. A motor vehicle having at least one actuator and an associated control unit which is configured to retrieve, from an internal memory of the motor vehicle, or externally download, at least one file, the at least one file including an . xml file, containing control commands for the at least one actuator via at least one data path determined by an NFT, and to implement the control commands as required.
